(19) United States
(12) Patent Application Publication
(10) Pub. No.: US 2011/0243378 A1
(43) Pub. Date: Oct. 6, 2011

(54) METHOD AND APPARATUS FOR OBJECT TRACKING AND LOITERING DETECTION

(75) Inventor: Jae-Hoon LEE, Changwon-city (KR)

(73) Assignee: SAMSUNG TECHWIN CO., LTD., Changwon-city (KR)

(21) Appl. No.: 12/871,256

(22) Filed: Aug. 30, 2010

(30) Foreign Application Priority Data
Apr. 2, 2010 (KR) 10-2010-0030505

(51) Int. Cl. G06K 9/00

(52) U.S. Cl. 382/103

(57) ABSTRACT

A method and apparatus for object tracking and loitering detection are provided. The method includes: wavelet-converting an input image by converting the input image into an image of a frequency domain to generate a frequency domain image and separating the frequency domain image according to a frequency band and a resolution; extracting object information including essential information about the input image from the frequency domain image; performing a fractal affine transform on the object information; and compensating for a difference between object information about a previous image and the object information about the input image by using a coefficient which is obtained by the fractal affine transform.

### CROSS-REFERENCE TO RELATED PATENT APPLICATION

This application claims priority from Korean Patent Application No. 10-2010-0030505, filed on Apr. 2, 2010, the disclosure of which is incorporated herein in its entirety by reference.

### BACKGROUND

1. Field

Apparatuses and methods consistent with exemplary embodiments relate to video monitoring, and more particularly, to object tracking and loitering detection.

2. Description of the Related Art

A network monitoring system usually obtains an input image by using a camera. Examples of the camera include a box-type camera and a pan/tilt/zoom (PTZ) type camera.

A box type camera usually transmits a fixed image scene from a fixed-type position. Accordingly, in an image scene transmitted using the box-type camera, the user may designate a region of interest on the fixed image scene for object tracking and loitering detection by line-drawing a polygon.

A PTZ type camera transmits a moving image scene by performing pan/tilt/zoom functions. Accordingly, the user needs to designate a region of interest each time pan/tilt/zoom functions are performed when using the PTZ type camera. Also, for performing object tracking and loitering detection on an image scene in which regions of interest are not preset, a manual operation of line-drawing by the user is needed each time a pan/tilt/zoom function is performed.

If the manual operation is omitted, object tracking and loitering detection are performed via a full range search with respect to all objects generated in an undefined preset region or may not be performed at all in the PTZ type camera.

Also, in an MPEG or H.264 format that is used for object tracking and loitering detection according to a related art, movement of a moving object in an image is simply represented two-dimensionally, and thus, it is difficult to represent rotation, disappearance, overlapping, size conversion, or the like of the moving object. In addition, when a large number of objects are included in the image, an amount of movement prediction and compensation calculation is increased excessively.

In order to address the foregoing problems, a size of a macroblock of a related art video image codec is further segmented, or a movement search range is widened or a pixel-based search region is segmented to conduct a search. However, a full search is not performed in the end, and thus, a local error is still generated during the search.

### SUMMARY

One or more embodiments provide methods and apparatus for object tracking and loitering detection in which a motion vector function is performed by using frequency information obtained by wavelet-converting an input image and fractal affine coefficient information of a fractal affine transform. Accordingly, the problems of the related art MPEG or H.264-based codec may be solved. Also, by using the fractal affine coefficient information, automatic object tracking and loitering detection may be performed.

According to an aspect of an exemplary embodiment, there is provided an apparatus for object tracking and loitering detection including: a wavelet converter which converts an input image into an image of a frequency domain to generate a frequency domain image, and divides the frequency domain image according to a frequency band and a resolution; a motion estimation unit which extracts object information including essential information about the input image from the frequency domain image and performs a fractal affine transform on the object information; and a motion compensation unit which compensates for a difference between object information about a previous image and the object information of the input image by using a coefficient which is obtained by the fractal affine transform.

The apparatus may further comprise a routing path analyzing unit which detects a plurality of routing paths of an object by using the object information about the input image and the coefficient, and sets a region of interest (ROI) of the input image as a searching area based on a frequency of appearance of each of the routing paths.

The apparatus may further comprise an object tracking and loitering detection unit which tracks another object which appears in the ROI of the input image.

According to an aspect of another exemplary embodiment, there is provided a video analyzing system including: a wavelet converter which converts an input image into an image of a frequency domain to generate a frequency domain image and divides the frequency domain image according to a frequency band and a resolution; a motion estimation unit which performs a fractal affine transform on the frequency domain image; a motion compensation unit which compensates for a difference between a previous image and the input image by using a coefficient which is obtained by the fractal affine transform; a routing path analyzing unit which sets a plurality of routing paths of an object by using the input image and the coefficient, and sets a region of interest (ROI) of the input image as a searching area based on a frequency of appearance of each of the routing paths; and an object tracking and loitering detection unit which tracks another object which appears in the ROI of the input image.

According to an aspect of another exemplary embodiment, there is provided a method of object tracking and loitering detection, the method including: wavelet-converting an input image by converting the input image into an image of a frequency domain to generate a frequency domain image and separating the frequency domain image according to a frequency band and a resolution; extracting object information including essential information about the input image from the frequency domain image; performing a fractal affine transform on the object information; and compensating for a difference between object information about a previous image and the object information about the input image by using a coefficient which is obtained by the fractal affine transform.

According to an aspect of another exemplary embodiment, there is provided a method of performing object tracking and loitering detection, the method including: wavelet-converting an input image by converting the input image into an image of a frequency domain to generate a frequency domain image and separating the frequency domain image according to a frequency band and a resolution; estimating a motion by performing a fractal affine transform on the frequency domain image; compensating motion by compensating for a difference between a previous image and the input image by using a coefficient which is obtained by the fractal affine transform; analyzing a routing path by setting a plurality of routing paths of an object by using the input image and the coefficient, and setting a region of interest (ROI) of the input image as a searching area based on a frequency of appearance of each of the routing paths; and tracking another object which appears in the ROI of the input image.

### BRIEF DESCRIPTION OF THE DRAWINGS

The above and other aspects will become more apparent by describing in detail exemplary embodiments with reference to the attached drawings in which:

FIG. 1 is an inner structural diagram of a related art video analytic/analysis system for object tracking and loitering detection;

FIGS. 2A and 2B illustrate examples of an image in which object tracking is performed, according to exemplary embodiments;

FIG. 3 is an inner structural diagram illustrating a system for automatic object tracking and loitering detection according to an exemplary embodiment;

FIGS. 4A through 4D illustrate wavelet conversion according to an exemplary embodiment;

FIG. 5 illustrates an image that is converted to various levels of frequency through wavelet conversion, according to an exemplary embodiment; and

FIG. 6 illustrates size conversion, rotation conversion, and scale conversion regarding a frequency block, according to an exemplary embodiment.

### DETAILED DESCRIPTION OF EXEMPLARY EMBODIMENTS

The present inventive concept will now be described more fully with reference to the accompanying drawings, in which exemplary embodiments of the invention are shown. The description and the attached drawings are for the understanding of the operations according to the exemplary embodiments, and parts that may be easily implemented by one of ordinary skill in the art may be omitted.

The detailed description and the drawings are provided not for purposes of limitation, and the scope of the present inventive concept is defined by the appended claims. The terms used herein should be construed as meanings and concepts not departing from the spirit and scope of the present inventive concept but as describing the present inventive concept in the most appropriate way.

An object tracking method refers to extracting a movement of an object in an image and continuously tracking a position of the object.

An object loitering detection method refers to detecting a movement path that an object in a predetermined area continuously loiters. By using the object loitering detection method, an intruder in a predetermined area may be monitored to prevent a crime from occurring.

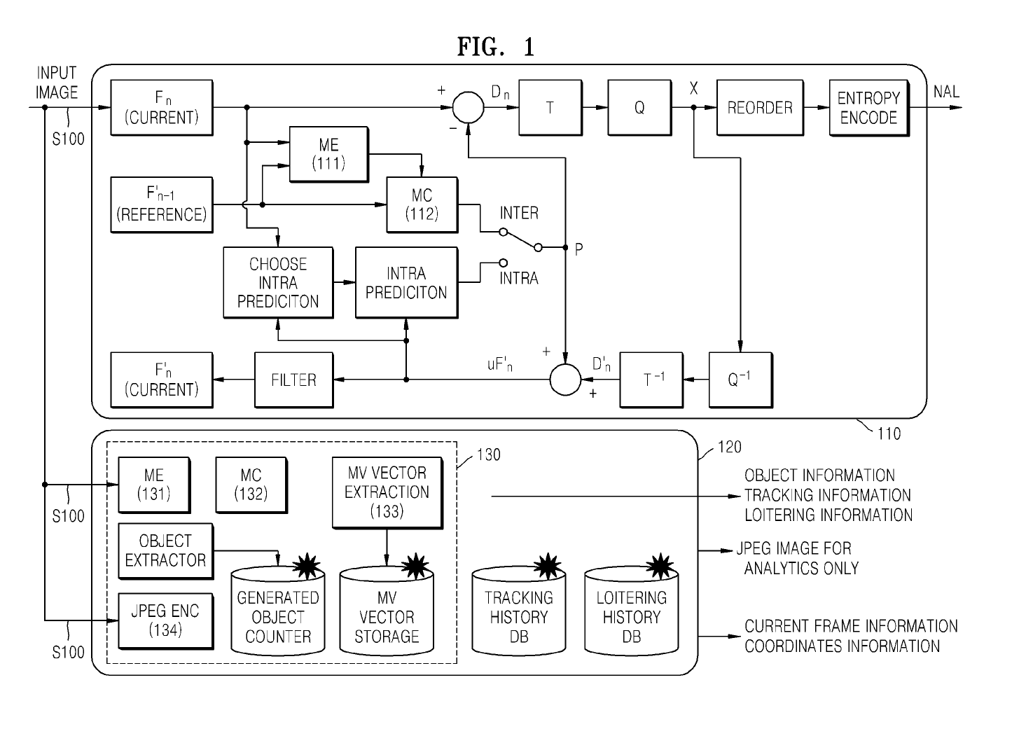

FIG. 1 is an inner structural diagram of a related art video analytic system for object tracking and loitering.

The video analytic system includes a video image compressing unit 110 and a video analyzing unit 120. As illustrated in FIG. 1, the video image compressing unit 110 has no interaction with the video analyzing unit 120 except receiving a same input image S100.

In detail, even though a motion estimation (ME) unit 111 and a motion compensation (MC) unit 112 of the video image compressing unit 110 extracts a motion vector and motion information, the video analyzing unit 120 has units denoted with a reference numeral 130 such as ME/MC units 131 and 132 that perform the same functions or similar functions. Accordingly, increase in the cost, excessive data traffic, and repeated logic realization when implementing a network system on chip (SoC) or application specific integrated circuit (ASIC) may occur. Also, loitering detection is conducted separately from a result of the performance of the ME/MC units 131 and 132 of the video analyzing unit 120, and thus the cost for implementing a system may be increased.

Also, the ME/MC unit 131 and 132 of the video analyzing unit 120 extract motion vectors based on tracking two-dimensional (2-D) coordinates in an MPEG-4 or H.264 format, as is the case of the ME/MC unit 111 and 112 of the video image compressing unit 110, and cannot effectively respond to position shifting of the object, rotation conversion, size conversion, disappearance, overlapping, or the like, and thus, may generate problems during object tracking and loitering detection.

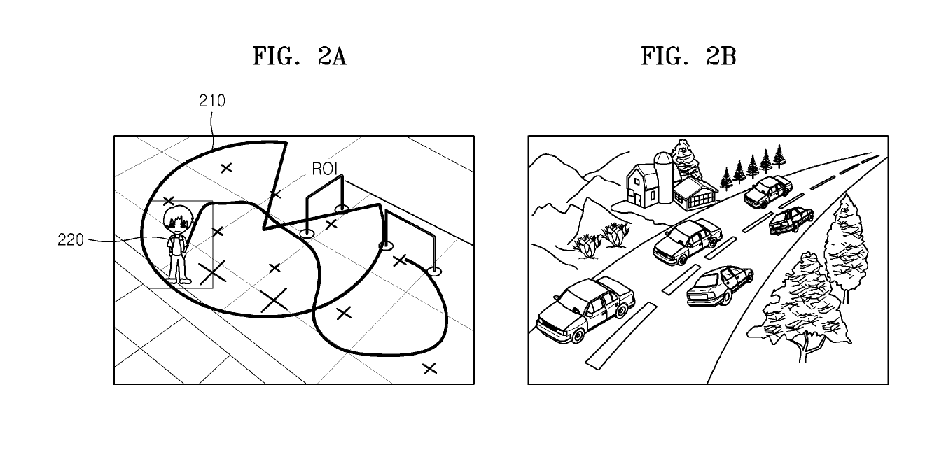

FIGS. 2A and 2B illustrate examples of images in which object tracking is performed, according to an exemplary embodiment.

In the related art video analytic system as illustrated in FIG. 1, a video image compression method such as MPEG-4 or H.264 is used to perform object tracking and loitering detection to obtain ME and MC.

In the video image compression method described above, a region of interest (ROI) 210 is set in an image that is to be monitored by the user, for object tracking and loitering detection. Then, an object 220 in the ROI 210 is selected and tracked.

However, in the above-described object tracking method, each of a plurality of objects that are generated are tracked based on a motion vector if a plurality of objects are randomly and frequently generated in an ROI as illustrated in FIG. 2B. Also, tracking needs to be conducted until all the generated objects disappear or for a predetermined period of time, and thus, tracking information (e.g., motion vector history) regarding each of the plurality of objects needs to be continuously maintained.

Accordingly, in a video image compression method based on an MPEG-4 or H.264 format, the number of calculations is excessively increased if the number of objects is increased. The excessive increase in the calculation leads to an increase in cost for implementing a system.

Also, in the video image compression method based on an MPEG-4 or H.264 format, ME/MC is performed based on 2-D motion, and accordingly, accurate tracking regarding three-dimensional (3-D) motion such as position shifting, rotation conversion, size conversion, disappearance, overlapping, or the like is difficult.

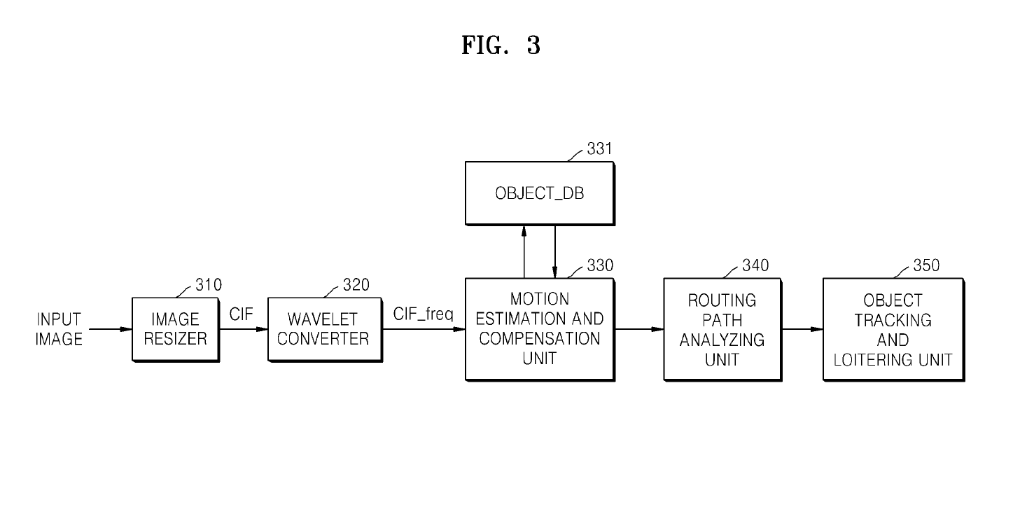

FIG. 3 is an inner structural diagram illustrating a system for automatic object tracking and loitering detection according to an exemplary embodiment.

In the system for automatic object tracking and loitering detection according to the current exemplary embodiment, frequency information about a wavelet-converted image and information about fractal affine coefficients of a fractal affine transform may be used to perform a motion vector function.

Accordingly, accurate tracking regarding a 3-D motion such as position shifting, rotation conversion, size conversion, disappearance, overlapping, or the like may be performed, and the problems caused when performing ME/MC based on 2-D motion using a related art video image codec may be solved.

The system for automatic object tracking and loitering detection according to the current exemplary embodiment includes an image resizer 310, a wavelet converter 320, an ME/MC unit 330, an object database (Object_DB) 331, a routing path analyzing unit 340, and an object tracking and loitering detection unit 350.

The image resizer 310 generates various images having different resolutions from an input image signal. Examples of the images having different resolutions are D1, Common Intermediate Format (CIF), Quarter CIF (QCIF), and the like. Next, the image resizer 310 outputs only one of the generated images. For example, only a CIF resolution image, and not a D1, CIF, or QCIF resolution image, is output.

According to the current exemplary embodiment, frequency conversion and motion information extraction are not performed with respect to all signals of a plurality of resolutions (e.g., D1, CIF, and QCIF). According to the current exemplary embodiment, signal conversion into a frequency domain and extraction of motion information are performed only one time through wavelet conversion to obtain output images having multiple resolutions.

For example, according to the current exemplary embodiment, when frequency conversion is performed with respect to one resolution, e.g., CIF, through wavelet conversion, object and motion frequency values of a CIF resolution image that is wavelet-converted are doubled to thereby obtain a D1 image having a four times the resolution of the CIF resolution image. Alternatively, the object and motion frequency values of the CIF resolution image that is wavelet-converted are halved to thereby obtain a QCIF resolution image, which is a quarter of the resolution of the CIF resolution image.

The wavelet converter 320 divides an input image according to a frequency band and a resolution through scaling and shifting. For example, upon receiving a CIF resolution image that is output by the image resizer 310, the wavelet converter 320 wavelet-converts the CIF resolution image to an image having a CIF frequency. The wavelet converter 320 divides the input image according to frequency ranges, and thus, coordinate conversion, rotation conversion, size conversion, etc., may be applied to the images having different frequency ranges.

According to the current exemplary embodiment, a fractal linear affine transform is used to perform size conversion, rotation conversion, and scale conversion. Accordingly, by using fractal affine coefficient information that is calculated by performing a fractal linear affine transform, a difference between a previous frame and a current frame may be detected.

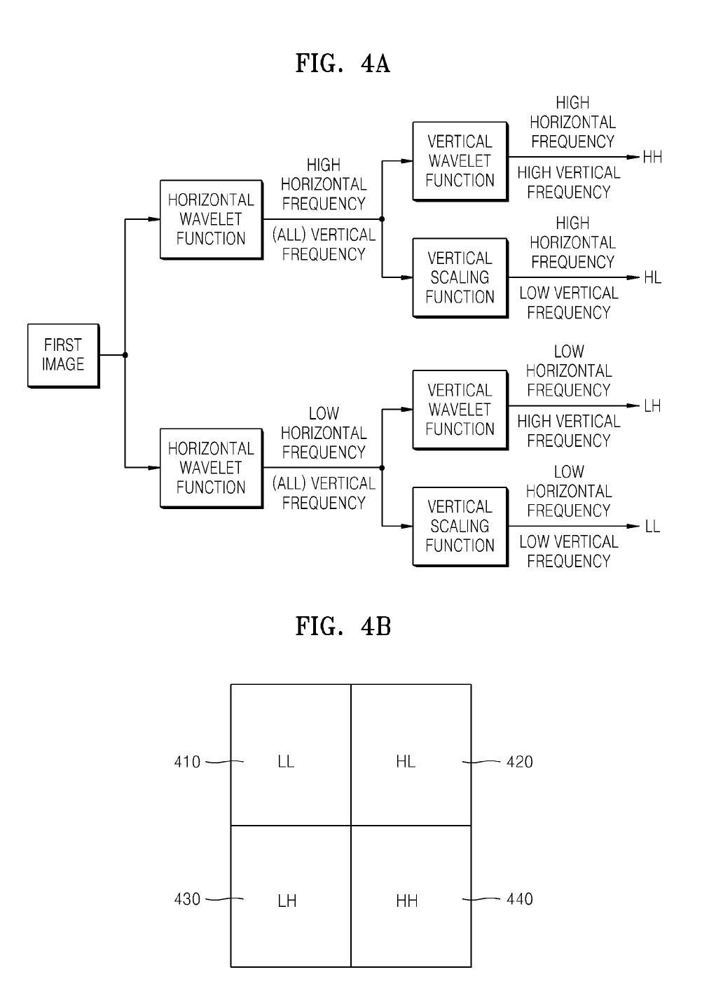

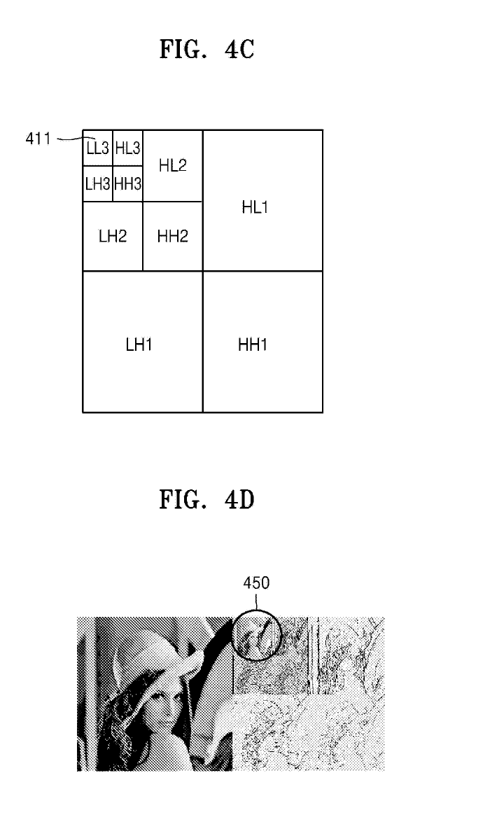

The ME/MC unit 330 extracts a block that is similar to the input image from an image that is configured by a wavelet-converted frequency signal. The block will be hereinafter referred to as object information. object information refers to data of a block of an input image that is passed through a low band pass filter in both vertical and horizontal directions during wavelet-conversion, and includes essential information about the input image. Referring to FIG. 4D, information about a block 450 that is similar to an original image corresponds to object information. FIGS. 4A through 4C illustrate a method of extracting object information.

Next, a difference between the extracted object information and object information about previous frames stored in the Object_DB 331 is calculated. The Object_DB 331 may include object information extracted from each of frames of the input image, an object ID, wavelet frequency information about the previous frames, or fractal affine coefficient information.

If the difference between the two pieces of object information is equal to or less than a previously set threshold value, the difference is stored in the Object_DB 331 by using a fractal affine coefficient. Accordingly, motion compensation between a current frame and a previous frame may be performed in the above-described manner.

When the difference of the two pieces of object information is greater than the previously set threshold value, the object information that is extracted from the current frame is discarded. For example, such a case may occur when a particular object is tracked and an obstacle suddenly passes in front of the object in the image.

By repeating the above-described operation, the object information and the fractal affine coefficient information in the Object_DB 331 are cumulatively updated, and thus, movement paths of an object may also be accumulated. Also, by using the fractal affine coefficient information, movement of an object in the current frame may be detected when compared to the previous frames. Accordingly, movement of all objects may be represented simply by each object's object information and fractal affine coefficients.

The routing path analyzing unit 340 determines routing paths of an object and a frequency of appearance of the object in each routing path by using the object information and the fractal affine coefficient information stored in the Object_DB 331, etc. Next, a region of interest (ROI) is defined based on the frequency of appearance of each routing path.

If a new object appears in the image, the object tracking and loitering detection unit 350 determines whether the object is within the ROI defined by the routing path analyzing unit 340. If the object is within the ROI, the object is automatically tracked. Also, tracking information about the object is automatically stored in the Object_DB 331.

FIGS. 4A through 4D illustrate wavelet conversion according to an exemplary embodiment. According to the current exemplary embodiment, the system for automatic object tracking and loitering detection performs signal conversion on a frequency band and extraction of motion information only one time through wavelet conversion to obtain output images having multiple resolutions, and thus, the processing time and the workload may be significantly reduced compared to a system in which signal conversion on frequency bands and extraction of motion information are performed with respect to signals of each of a plurality of resolutions.

The method of wavelet-conversion will be described in detail with reference to FIGS. 4A through 4C.

A wavelet-converted first image data is first converted to four sub-images. That is, with regard to the first image data, an LL block 410 that is generated by applying a low band pass filter in both horizontal and vertical directions to the first image data, an HL block 420 that is generated by applying a high band pass filter in the vertical direction to the first image data and a low band pass filter in the horizontal direction to the first image data, an LH block 430 that is generated by applying a high band pass filter in the horizontal direction to the first image data and a low band pass filter in the vertical direction to the first image data, and an HH block 440 that is generated by applying a high band pass filter in both the vertical and horizontal directions to the first image data are generated.

The HL block 420 includes frequency error components in the vertical direction, and thus, has a clear horizontal boundary, and the LH block 430 includes frequency error components in a horizontal direction, and thus, has a clear vertical boundary. Also, the HH block 440 has a clear diagonal boundary. Also, the low band pass filter is applied to the LL block 410 both in vertical and horizontal directions, and thus, an image similar to the first image is generated in the LL block 410. Also, the LL block 410 includes essential information of the first image. By repeatedly filtering the approximate image, that is, the LL block 410, frequency conversion of the first image data to various levels of frequency block may be performed.

A base function Ψ_{j,k}(t) for wavelet conversion is shown as Equation 1 below.

Ψ_{j,k}(t)=2^{j/2}Ψ(2^{j}t−k) [Equation 1]

An input image signal f(t) may be represented by Equation 2 below by using the base function. In Equation 1, t denotes time, j denotes a scale parameter, and k denotes a motion parameter corresponding to a time axis.

$$f ( t ) = {\sum }_{j , k} {a}_{j , k} {Ψ}_{j , k} ( t ) \qquad [ Equation 2 ]$$

In Equation 2, a_{j,k} denotes a wavelet coefficient. In a multi-resolution analysis using a wavelet, there are a scale function Φ(t) and a wavelet function Ψ(t). Here, an input image signal f(t) may be represented by Equation 3 below.

$$\begin{matrix}f ( t ) = {\sum }_{j , k} {c}_{j} ( k ) {Φ}_{j , k} ( t ) + {\sum }_{j , k} {d}_{j} ( k ) {Ψ}_{j , k} ( t ) \\ = {\sum }_{j , k} {c}_{j} ( k ) {2}^{j / 2} Φ ( {2}^{j} t - k ) + \\ {\sum }_{j , k} {d}_{j} ( k ) {2}^{j / 2} Ψ ( {2}^{j} t - k )\end{matrix} \qquad [ Equation 3 ]$$

As a result of the wavelet conversion, the input image is divided according to a frequency band and a spatial region. Also, by dividing the input image according to a frequency band and a resolution, the input image may be converted as illustrated in FIG. 4D.

FIG. 4D illustrates an example of an image signal that is divided according to a frequency band and a resolution through wavelet conversion.

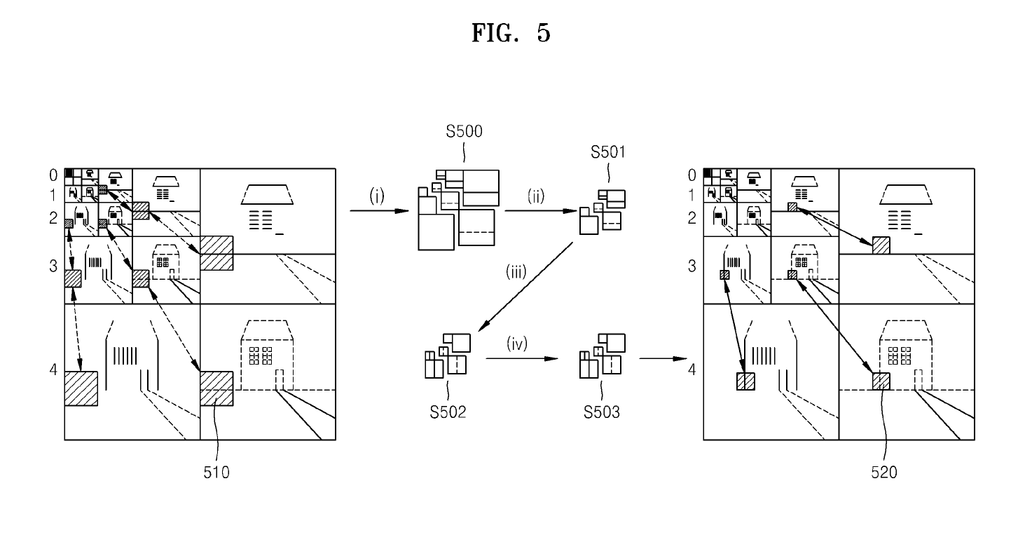

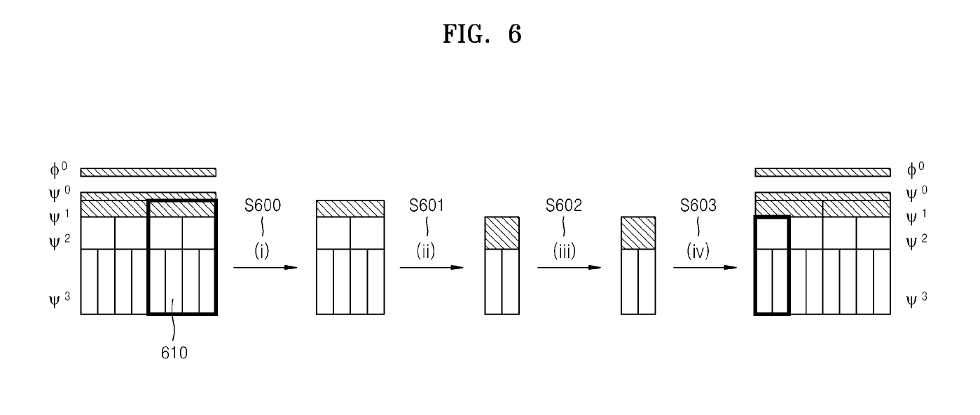

FIG. 5 illustrates an example of an image that is converted to various levels of frequency through wavelet conversion.

When converting an image or image data through wavelet-conversion as illustrated in FIG. 4, if a filtering operation is repeated, a frequency of the image or image data may be converted to various other frequencies as illustrated in FIG. 5. The other frequencies may also be represented by other frequency ranges through, for example, coordinate conversion, rotation conversion, size conversion, etc.

An area 510 that is illustrated with oblique lines in a left portion of FIG. 5 is a first frequency region that is selected by the user, and an area 520 illustrated with oblique lines in a right portion of FIG. 5 is a first image region that is converted from the first frequency region through, for example, coordinate conversion, rotation conversion, size conversion, etc.

In detail, (i) the first frequency region selected by the user is extracted from each of blocks (S500). (ii) A size of the extracted first frequency region is converted (S501). (iii) After the size conversion, the first frequency region is rotated (S502). (iv) The converted first frequency region and the original first image region are compared (S503). That is, whether a frequency block of the finally converted first frequency region and a frequency block of the original first image region are consistent is determined. Here, size conversion, rotation conversion, and scale conversion of the frequency region may be repeatedly performed, and the order of conversions may also be changed.

If the two frequency blocks are consistent, degrees of size conversion, rotation conversion, and scale conversion are detected. The degrees of size conversion, rotation conversion, and scale conversion may be detected by detecting fractal affine coefficients of the fractal affine transform that is performed to the extracted object.

For example, size conversion or scale conversion may be detected from x and y among fractal affine coefficients x, y and z, and an angle may be detected from z to thereby detect the degree of rotation conversion.

As described above, frequency information of the wavelet-converted image and the fractal affine coefficients of the fractal affine transform may be served as a motion vector.

FIG. 6 illustrates size conversion, rotation conversion, and scale conversion regarding a frequency block.

(i) A first frequency region 610 is extracted from an image (S600). (ii) A size of the extracted first frequency region 610 is converted (S601). (iii) A scale of the first frequency region 610 is converted after size conversion (S602).

(iv) Whether a frequency block of the converted first frequency region and a frequency block of the original first image region are consistent is determined (S603). If the two frequency blocks are consistent, fractal affine coefficients corresponding to size conversion, rotation conversion, and scale conversion of the two consistent frequency blocks are detected. The detected fractal affine coefficients may be used to detect error in central coordinates or error in rotation angles.

According to the exemplary embodiments, an image analysis is possible even when an object generated in an image moves not only two-dimensionally but also three-dimensionally. Also, object tracking and loitering detection may be performed based on a result of analyzing the object in the image.

While the present inventive concept has been particularly shown and described with reference to the exemplary embodiments thereof, it will be understood by those of ordinary skill in the art that various changes in form and details may be made therein without departing from the spirit and scope of the present inventive concept as defined by the following claims.

What is claimed is:

1. An apparatus for object tracking and loitering detection comprising:
image resizer which generates a plurality of images having different resolutions based on an input image;
a wavelet converter which converts one of the plurality of images having different resolutions into an image of a frequency domain to generate a frequency domain image according to a frequency band;
a motion estimation unit which extracts object information including essential information about the input image from the frequency domain image and performs a fractal affine transform on the object information; and
a motion compensation unit which compensates for a difference between object information about a previous image and the object information of the input image by using a coefficient which is obtained by the fractal affine transform.

2. The apparatus of claim 1, further comprising a routing path analyzing unit which detects a plurality of routing paths of an object by using the object information about the input image and the coefficient, and sets a region of interest (ROI) of the input image as a searching area based on a frequency of appearance of each of the plurality of routing paths.

3. The apparatus of claim 2, further comprising an object tracking and loitering detection unit which tracks another object which appears in the ROI of the input image.

4. The apparatus of claim 1, wherein the object information comprises data which is generated by applying a low band pass filter to the input image in vertical and horizontal directions by using the wavelet-converter.

5. The apparatus of claim 1, wherein the input image is constituted in only one resolution.

6. A video analyzing system comprising:
image resizer which generates a plurality of images having different resolutions based on an input image;
a wavelet converter which one of the plurality of images having different resolutions into an image of a frequency domain to generate a frequency domain image according to a frequency band;
a motion estimation unit which performs a fractal affine transform on the frequency domain image;
a motion compensation unit which compensates for a difference between a previous image and the input image by using a coefficient which is obtained by the fractal affine transform;
a routing path analyzing unit which sets a plurality of routing paths of an object by using the input image and the coefficient, and sets a region of interest (ROI) of the input image as a searching area based on a frequency of appearance of each of the plurality of routing paths; and
an object tracking and loitering detection unit which tracks another object which appears in the ROI of the input image.

7. The video analyzing system of claim 6, wherein the motion estimation unit performs the fractal affine transform only on information about a block of the frequency domain image which corresponds to data of the input image whose frequency is converted by applying a low band pass filter both in vertical and horizontal direction using the wavelet converter, among information of the frequency domain image.

8. The video analyzing system of claim 6, further comprising an object database which stores information about the object and the coefficient obtained through the fractal affine transform.

9. The video analyzing system of claim 8, wherein the object database discards information related to the input image if a difference between the previous image and the input image is over a previously set threshold value.

10. The video analyzing system of claim 6, wherein the input image is constituted in only one resolution.

11. A method of performing object tracking and loitering detection, the method comprising:
generating a plurality of images having different resolutions based on an input image;
wavelet-converting one of the plurality of images having different resolutions into an image of a frequency domain to generate a frequency domain image according to a frequency band;
extracting object information including essential information about the input image from the frequency domain image;
performing a fractal affine transform on the object information; and
compensating for a difference between object information about a previous image and the object information about the input image by using a coefficient which is obtained by the fractal affine transform.

12. The method of claim 11, further comprising:
detecting a plurality of routing paths of an object by using the object information about the input image and the coefficient; and
setting a region of interest (ROI) of the input image as a searching area based on a frequency of appearance of each of the plurality of routing paths.

13. The method of claim 12, further comprising tracking another object which appears in the ROI of the input image.

14. The method of claim 11, wherein the object information comprises data which is generated by applying a low band pass filter to the input image in vertical and horizontal directions.

15. The method of claim 11, wherein the input image is constituted in only one resolution.

16. A method of performing object tracking and loitering detection, the method comprising:
generating a plurality of images having different resolutions based on an input image;
wavelet-converting one of the plurality of images having different resolutions into an image of a frequency domain to generate a frequency domain image according to a frequency band;
estimating a motion by performing a fractal affine transform on the frequency domain image;
compensating motion by compensating for a difference between a previous image and the input image by using a coefficient which is obtained by the fractal affine transform;
analyzing a routing path by setting a plurality of routing paths of an object by using the input image and the coefficient, and setting a region of interest (ROI) of the input image as a searching area based on a frequency of appearance of each of the plurality of routing paths; and
tracking another object which appears in the ROI of the input image.

17. The method of claim 16, wherein, in the estimating a motion, the fractal affine transform is performed only on information about a block of the frequency domain image which corresponds to data of the input image whose frequency is converted by applying a low band pass filter both in vertical and horizontal direction using the wavelet converter, among information of the frequency domain image.

18. The method of claim 16, further comprising storing information about the object and the coefficient obtained through the fractal affine transform.

19. The method of claim 18, further comprising discarding information related to the input image if a difference between the previous image and the input image is over a previously set threshold value.

20. The method of claim 16, wherein the input image is constituted in only one resolution.
